(19) United States
(12) Patent Application Publication
(10) Pub. No.: US 2024/0154187 A1
(43) Pub. Date: May 9, 2024

(54) Hybrid Low-Temperature Battery with an Intelligent Control System

(71) Applicants: Yoka Cho, Toronto (CA); Hossam Gaber, North York (CA)

(72) Inventors: Yoka Cho, Toronto (CA); Hossam Gaber, North York (CA)

(73) Assignees: Yoka Cho, Toronto (CA); Hossam Gaber, North York (CA)

(21) Appl. No.: 17/388,367

(22) Filed: Jul. 29, 2021

(51) Int. Cl. H01M 10/42; H01M 10/44; H01M 12/02

(52) U.S. Cl. CPC H01M 10/4257; H01M 10/441; H01M 10/443; H01M 12/02; H01M 2010/4271; H01M 2010/4278

(57) ABSTRACT

The patent presents hybrid low temperature battery (HLTB) as a design and control that can deliver electrical energy in stationary and mobile application at temperature from −40° C. with a lower total cost than normal ultralow temperature battery technologies. HLTB integrates two types of batteries, a smart controller and a heater into an insulated chamber. One of the batteries is normal battery that works from −20° C. and another one can discharge from −40° ° C. which powers the heater to warm up the normal batteries when the temperature drops lower than −20° C.

The objective of the patent is to achieve a novel design of integrated hybrid battery system employing existing battery technologies, which extends the operation temperature of normal battery with limited extra cost. There are some challenges related to HLTB system, one of which is the management of two different batteries. Other challenges are optimization of the two batteries group ratio, which is a trade-off between warming up speed and cost.

The patent will include innovations that can be performed as novel design of Hybrid Low Temperature Battery (HLTB) technology, which is applied to electric vehicles and stationary energy storage in various scales. The energy storage management system will provide optimised features to ensure minimum consumption of ultralow temperature battery that costs several times of normal ones, and monitor temperature, voltage, and current of each battery cell and balance the output of each battery to extend the life of whole system. Housing and packaging design will ensure minimum heat loss during low temperature to reduce the heating load before the system starts to discharge and ensure the temperature cannot rise over the upper limit of normal battery.

The patent presents Hybrid Low Temperature Battery (HLTB) with intelligent control system that can discharge at ultralow temperature with a lower tonal cost than other ultralow battery technologies. HLTB has built-in normal temperature battery (NTB) operating at moderate temperature range, ultralow temperature battery (LTB) that has lower discharge temperature but higher cost than normal one, hater, temperature sensor, heat pipe and intelligent battery management that control and switch the start of ultralow temperature battery group and normal temperature battery group, based on the environment temperature.

The objective of the project is to achieve a novel design of integrated hybrid low temperature battery system. Two groups of batteries are optimally combined with hater, heat pipe and intelligent battery management system (IBMS) into an insulation housing. All the status will be monitored and controlled by IBMS that can communicate with remote end control devices

The system will work in the following scenarios:
   If the environment temperature is lower than the limit of the (LTB). BMS sends out an alert message and reject to start
   Or if the temperature is higher that the lower limit of (LTB) but lower than the lower limit of NTB, BMS initiate the LTB to power heater attached to NTB to worm up it. Once the temperature reaches the lower limit of NTB, IBMS stops the output of LTB and allow NTB to output power to the load.
   Once the temperature inside reaches certain value close to the upper limit of NTB, integrated beat pipes start to work automatically due to its fixed evaporating temperature and release unnecessary heat generated from NTB to the environment to ensure the NTB works proper temperature range.

There are some challenges related to the HLTB system, one of them is the optimization between heating speed and cost of ITS, heat pipe design, integration of insulation at low temperature and heat disputation when temperature becomes high Other challenges are trade-off between performance and cost/complexity.

HLTB is an effective technology to supply electrical energy in cold environment with acceptable cost. It can be applied to vehicles such as EV, E-Bus or E-boat and off grid energy storage application in cold area to replace the battery employing advanced and expensive chemical materials. The cost of Normal temperature battery has been dropping dramatically because increasing mass production. However, its optimal operation temperature is limited to a moderate range, which prevents its application in cold area. And its energy efficiency and life cycle are greatly decreased when temperature is low. On the other hand, ultralow temperature battery has opposite specification to NTB, i.e. lower operation range but much more expensive. HLTB utilizes LTB to supply moderate working environment to NTB which works as major power source to output, which expands the operation temperature range of NTB, and improves its energy efficiency and extends its life cycle.

The energy storage management system will provide resilient features to ensure minimum operation interruptions and higher availability using self-healing and fault tolerant control mechanisms that can effectively decide the charging/discharging of each battery units.

The proposed framework for HLTB energy storage system can be highlighted as:
Wide working temperature range
Low cost
Intelligent energy storage management

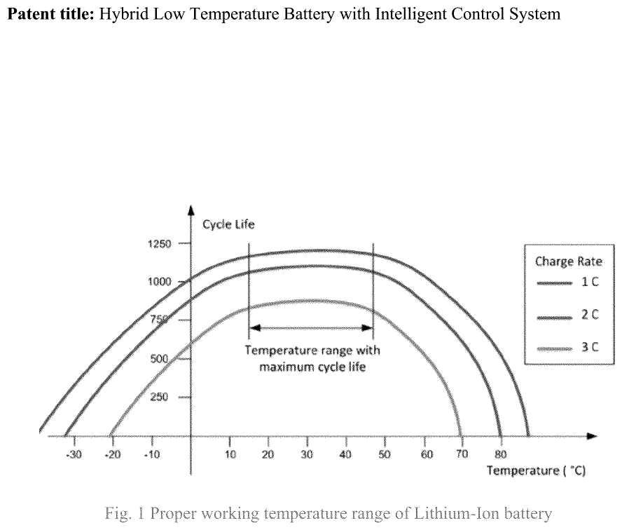

FIG. 1: Optimal operating temperature of typical normal temperature lithium-ion battery. It is well-know that the lithium-ion battery performs well at elevated temperature. Manufactures of Li-ion battery usually gives the operation temperature of normal temperature working battery to range from 0 to 45° C. for charging operations, and −20 to 55° C. for discharging operations.

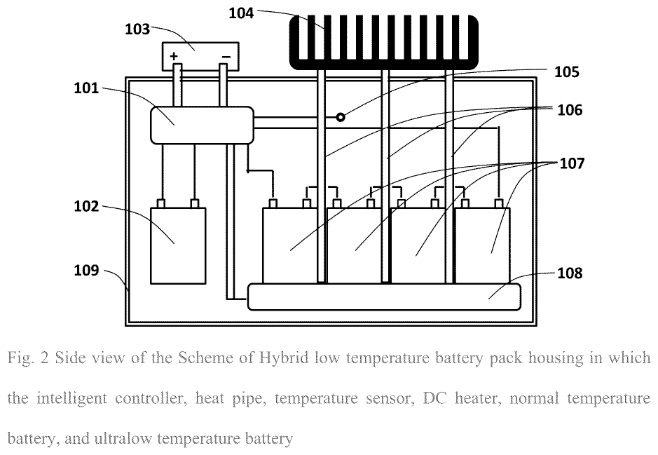

FIG. 2: Side view of the Scheme of Hybrid low temperature battery pack housing in which the intelligent controller, heat pipe, temperature sensor, DC heater, normal temperature battery, and ultralow temperature battery
101. Intelligent Battery Management System (IBMS)
102. Ultralow temperature batter (LTB) or other electrical energy storage device
103. Electrical connector to the load
104. Heat sinks connecting to the beat pipes 106, and attaching to the housing 109
105. Temperature sensors
106. Heat pipes with certain pressure which enable one-way heat conduction once temperature over certain value.
107. Normal Temperature Batter (NTB)
108 DC heater powered by LTB 102 and supplying heat to NTB 107
109. Insulated housing

NTB and LTB are optimally combined with heater, beat pipe and intelligent battery management system (IBMS) into an insulation housing. All the status will be monitored and controlled by the IBMS that can communicate with remote end control devices. The heater driven by LIB can supply heating to NTB can ensure the NTB can stare to work well when the environment temperature is lower than its bottom limit Once the temperature of NTB reach its working temperature range, the IBMS will stop the LTB and turn on the discharging circuit of NTB to let it discharge to the load. Due to the well-designed insulation housing, once the NTB start to discharge, the heat generated due to its internal resistance will keep the NTB battery group work about its lowest temperature limit. Meanwhile, the IBMS monitors the temperature of NTB and its state-of-charge (SOC), and turn the heater driven by 178 to rise up the temperature for some cases the environment is too cold, and the heat generated from NTB it self can not maintain the temperature. On the other hands, once the temperature inside reaches certain value close to the upper limit of NTB, integrated heat pipes start to work automatically to damp the extra heat out of the housing Due to the optimized evaporating temperature, the heat pipe only starts to emit the heat when the inside temperature is close to the upper limit of NTB, which ensure it work within a proper temperature range. The boiling point of the liquid filled in the vertically placed heat pits is optimized by adjusting the pressure inside of the beat pipe.

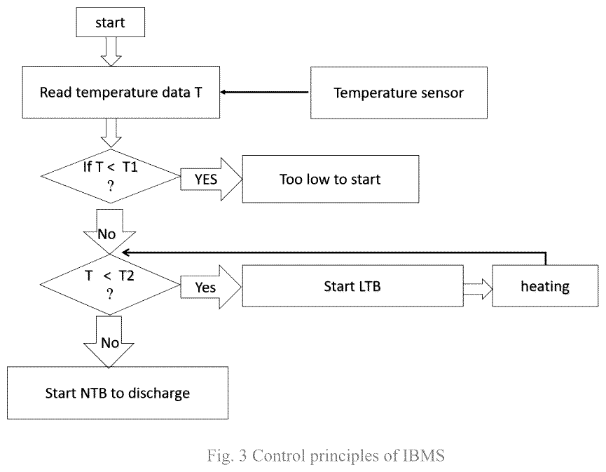

FIG. 3 Working principles of the control system logic

The system working starts with sensing the temperature as FIG. 3 shown A temperature sensor will sense the real-time temperature of NTB ‘T’, and this data will be sent to ISMS. For extremely cold scenarios if T<T1, then neither LTB nor NTB will work. Otherwise, if it is warm enough to let LTB work: i.e. T>T1 then IBMS will check whether T<T2. If it is true, then IBMS will start LTB to warm the NTB by DC heater till T>T2, then ISMS will turn off LTB and turn on NTB and it starts discharging to the load automatically. The state-of-charge (SOC) for both of LTB and NTB will always monitored by the IBMS.
T1: bottom limit of ultralow temperature battery
T2: bottom limit of normal temperature battery
T: real time temperature of NTB

Thanks to the optimized boiling point temperature design, the heat pipe only starts to work once the temperature inside of the insulated housing is close to the upper limit of NTB. This design ensures the heat pipe works as an one-way temperature activated heat pipe to dissipate the extra beat to the environment, which ensure the battery housing keep warm but will not overheated.

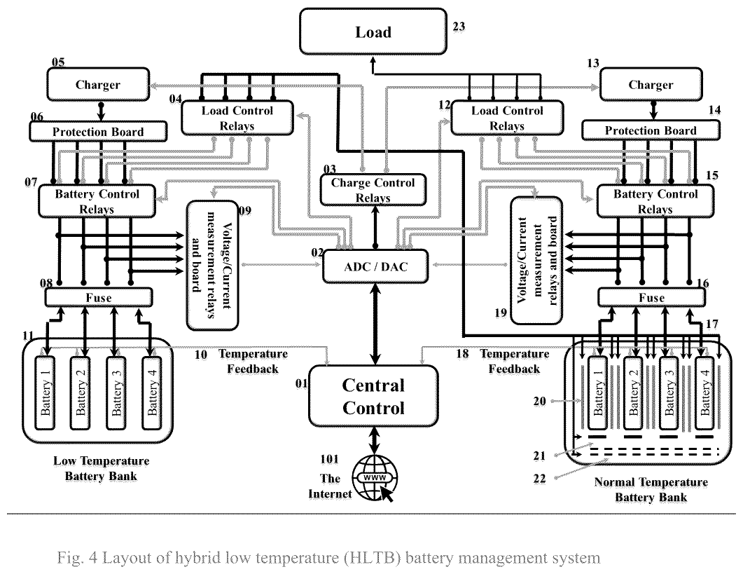

FIG. 4: Layout of hybrid low temperature (HILTS) battery management system
01. Digital Computer, the main controller of the system. The employed Raspberry Pi is able to manage multiple ADC/DAC. This Raspberry Pi can connect to the Internet via WIFI and can be controlled front anywhere of the world.
02. ADC/DAC: an Analog to Digital (ADC) and Digital to Analog (DAC) converter Arduino Micro is used as ADC. The built-in DAC of Pi has been used. This Arduino, is connected with the Raspberry Pi. The Arduino Micro operates based on the command getting from the Raspberry Pi. Arduino Uno has both analog and digital pin.
03. Control Relays: These relays will control the chargers. These relays will determine the connection between charger and power source to charge the Low Temperature Battery (LTB) and Normal Temperature Battery (NTB)
04. Load Control Relays of LTB: These relays will control the connection between load and battery. For LTB, the load is heater (placed with NTB). AZ979-IC-12DRC1 (60A) relay was employed for this purpose. These relays will be controlled by DAC. There are options to control the relays with Arduino.
05. Charger for LTB: These chargers are used to charge the LTB.
06. Protection Board for LTB: These boards are required to ensure the proper charging of each battery in the bank, for both LTB and NTB. Detail connection diagram and description are given in the following pages.
07. Battery Control Relays: These relays are used to control the connection between the charger and flattery (NTB and LTB). These relays will be controlled by built-in DAC of Pi. There is an option to control them with Arduino.
08. Fuse: The power is passed through a fuse for short circuit protection.
09 Voltage/Current Measurement. This is used to measure the voltage and current of the battery bank. This will be connected to the analog pin (ADC) of Arduino. Based on the feedback from voltage and current measurement board, the control program will ensure the over voltage, over current, under voltage, and under current protection. Other type of ADC, e.g., MCP3008 could be used, but Arduino found to be the easiest and cheapest solution Number of MCP3008 use is limited by the pins of Pi whereas we can connect many Arduinos to Pi and get 12 ADCs from each Arduino, Micro.
10. Temperature Sensor: The temperature sensor are used to measure the temperature from the battery bank. We used DS1822 temperature sensors. One temperature sensor is placed in the LTB battery bank There are three pins in DS1822 that are ground, VDD, and data (DQ). The temperature sensor will be connected with Raspberry Pi. The temperature sensor will be connected at pin 1/17, 6/20, 7.
11. LTB: These are the ‘Low Temperature Battery’, which can work at as low as −40 degrees Celsius/Fahrenheit. Now a days these types of batteries are being called Ultra Low Temperature Battery
12. Load Control Relays. These relays will control the connection between load and battery. For LTB, the load is heaters and fans, placed with NTB. AZ979-IC-12DRC1 (60A) was employed as relay. These relays will be controlled by built-in DAC of Pi with an option to control with the digital pins of Arduino
13. Charger: Charger is used to charge the LTB.
14. Protection Board for NTB: These boards are required to ensure the proper charging of each battery in the bank, for both LTB and NTB. Detail connection diagram and description are given in the following pages.
15. Battery Control Relays for NTB: These relays are used to control the connection between the charger and Battery. These relays will be controlled by built-in DAC of Pi with the option control with the Arduino.
16. Fuse for NTB: The power is passed through a fuse for short circuit protection.
17. NTB: ‘Normal Temperature Battery’, which cannot discharge when the temperature is below −20 degree Celsius Now-a-days these types of batteries are being called Low Temperature Battery.
18. Temperature Sensor: The temperature sensor is used to measure the temperature from the battery bank. We used DS1822 temperature sensor. Temperature sensor is placed in each battery. There are three pins in DS1822 that are ground. VDD, and data (DQ). The temperature sensor will be connected with Raspberry Pi. The temperature sensor will be connected at pin 1/17, 6/20, 7.
19. Voltage/Current Measurement: This is used to measure the voltage and current of the battery bank. This will be connected to the analog pin of (DAC) of the Arduino. Based on the feedback from voltage and current measurement board the control program will control the ‘Battery Control Relays’ to ensure the over voltage, over current: under voltage: and under current protection.
20. Side Heaters: Side heaters are used to heat NTB. One side heater is attached to each side of each NTB, i.e. total eight side heaters are used Total wattage of the side beaters is about 150 watts.
21. Bottom Heaters: Bottom heaters are used to heat NTB. Total eight PTC type bottom heaters are installed in two banks under the NTBs. Each heater is about 50 watts, total is about 400 watts. All eight will be too much load for the LTBs, if turned on simultaneously which is why they are separated in two banks.
22. Fan assembly to circulate the hot air
23. Load: This is the actual load, e.g. lights, fans, motors etc. served by the NTB. The loads are connected via load control relays and controlled by the DAC of Pi with the option to control with Arduino

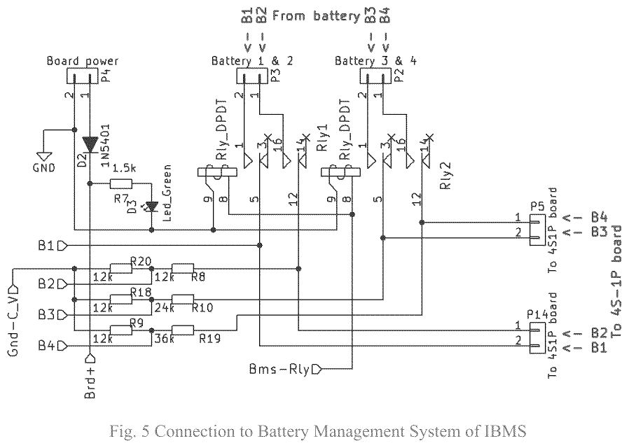

FIG. 5 shows connection to battery management system of IBMS. A BMS is used to control the charging of Lithium-Ion batteries. The BMS could connect directly to the batteries. The BMS and voltage dividers draw quiescent current (IQ). The purposes of these relays are to make sure that the batteries don't get drained when the system is powered-off for a prolong period of time.

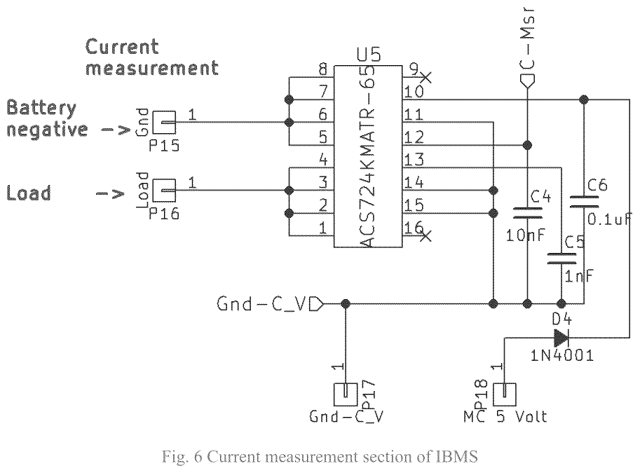

FIG. 6 shows current measurement section of IBMS. An ACS724KMATR semiconductor is used for this purpose.

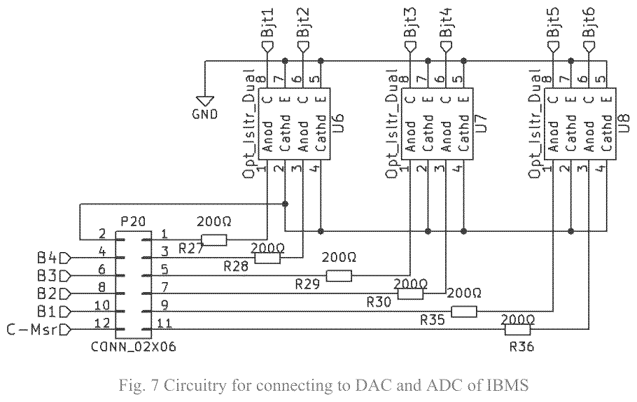

FIG. 7 shows circuitry for connecting to DAC and ADC of IBMS. Pins 4, b, 8 and 10 are analog battery voltage output and fed to the ADC Pin is the analog current measurement output and fed to the ADC. Pins 1, 3, 5, 7, 9 and IL are input from the DAC of Raspberry Pi. Pin 2 is the ground connection from Pi. To get the actual voltage from the analog reading some calculations are needed, as we used voltage dividers to bring down the given-up by the 2^{nd} to 4th batteries so that they are tolerable for the ADC.

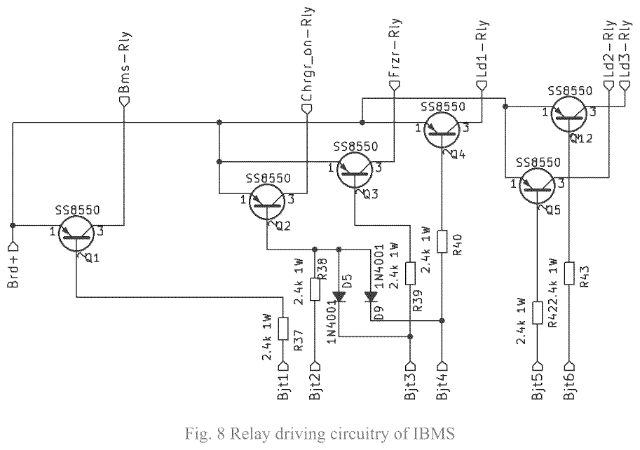

FIG. 8 shows relay driving circuitry of IBMS The opt isolators may not sink/source enough current for the relays. Transistors are used to amplify the current.

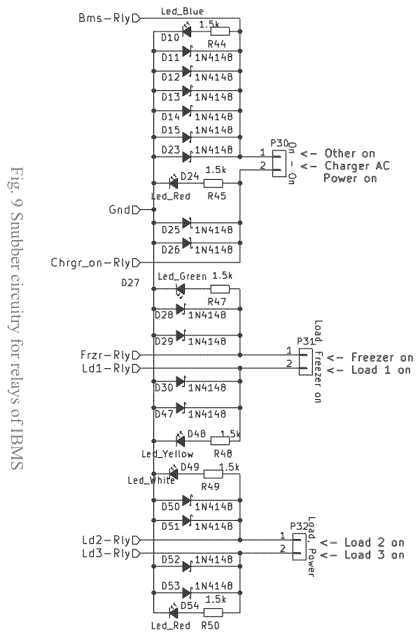

FIG. 9 shows snubber circuitry for relays of IBMS This circuitry is needed for purging any abnormal voltage excursion and to reduce the EMI.

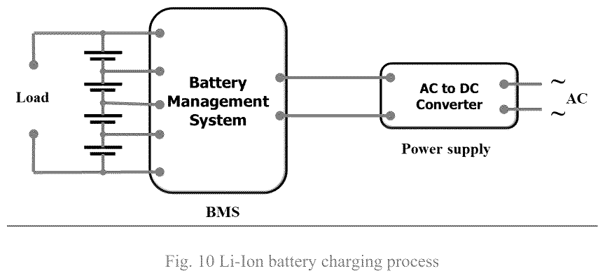

FIG. 10 shows the Li-Ion battery charging process. For charging Lithium-Ion batteries, in this project LiFePO₄, a charging-control board is required as shown in the Figure.

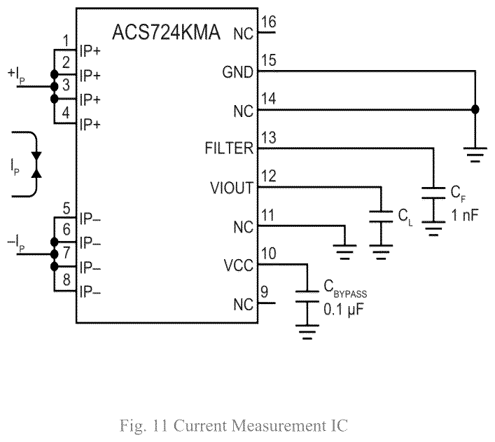

FIG. 11 shows current measurement IC ACS724KMATR. It helps monitor the current flow to and from the batteries which can help to know the SOC of the batteries while being charged or discharged

1. Design and Demonstrate Hybrid Low temperature Battery (HLTB) that can improve performance and lifetime of battery working in cold temperature with reduced cost. The hybrid battery system comprising:
A group of Normal temperature battery (NTB), said normal temperature rechargeable battery only can work at environment with over −20 Celsius degree, including positive and negative terminals; a group of Low/ultralow Temperature Battery (LTB), said having much lower working temperature range than NTB, and lower capacity build up in the HLTB, only discharge to the heater attached to NTB, including positive and negative terminals; and an insulated housing which is normally closed with a removeable cover, is able to prevent the heat loss to the environment to accelerate the temperature to reach the optimum working range of NTB, the NTB and LTB being positioned in the housing, the housing having positive and negative terminal for charge and discharge, the positive terminal of housing being connected to the positive of NTB, and the negative terminal of the housing being connected to the negative terminals of NTB. A one-way heat-pipe, placed in the housing to dampe the extra heat to the environment while the heat generated by NTB is unnecessary and the temperature of NTB is close to its up limit, is able to protect the NTB from overheat, and an intelligent control unit, managing both NTB and LTB depending on the temperature data acquired via temperature sensors attached to the out surface of housing, NTB (even inside), LTB.

2. A hybrid power supply in accordance with claim 1, wherein: said the HLTB is suitable as starter battery for vehicle driven by convectional fuel, or energy storage for vehicle driven by electric motor, and stationary energy storage in cold climate for distributed energy, renewable energy, a back up energy.

3. A hybrid power supply in accordance with claim 1, wherein: said NTB cells each have a substantially identical nominal voltage.

4. A hybrid power supply in accordance with claim 1, wherein: said LTB cells each have a substantially identical nominal voltage.

5. A hybrid power supply in accordance with claim 1, wherein: The NTB and LTB have different working temperature range, where the LTB has much lower discharge temperature limit than the secondary battery.

6. A hybrid power supply in accordance with claim 1, wherein: said NTB cell has less cost for energy storage than said LTB cell.

7. A hybrid power supply in accordance with claim 1, wherein: said NTB can be any type of electrochemical rechargeable battery including lithium ion battery, lead acid battery, etc. which can work at normal temperature range with relatively low cost.

8. A hybrid power supply in accordance with claim 1, wherein: said LTB can be any type of electrochemical rechargeable energy storage device that has much lower working temperature than NTB, including battery, and capacitor.

9. A hybrid power supply in accordance with claim 1, wherein: said LTB is only discharging to the heater attached to the NTB, and it stops working once the temperature of NTB is heated up to its working range.

10. HLTB develop Intelligent Battery Management System (IBMS) to monitor temperature and state of charge (SOC) for both NTB and LTB battery cells, calculate the available capacity, control the start of NTB and LTB batteries, balance the cells and communicate with the load side.

11. Intelligent Battery Management System which includes two battery management circuits with temperature sensor reading and can work under −40 Celsius degree.

12. The battery and heater combination of claim in which the thermostatically controlled switch can be adjusted via controlling software via developed battery management system in claim 11.
